(19) United States
(12) Patent Application Publication
(10) Pub. No.: US 2005/0273833 A1
(43) Pub. Date: Dec. 8, 2005

(54) Customized virtual broadcast services

(75) Inventor: Markku Soinio, Espoo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/845,494

(22) Filed: May 14, 2004

(51) Int. Cl. H04N 5/445; G06F 3/00; H04H 9/00; H04N 7/16; H04N 7/173

(52) U.S. Cl. 725/113; 725/112; 725/145; 725/9; 725/109

(57) ABSTRACT

A system for representing virtual channels of a broadcast genre type in a display of an IP datacasting receiver is disclosed. Aspects of the invention are applicable to video and audio broadcasting via IP over Digital Video Broadcast (DVB) or IP time slicing over DVB. In one arrangement, the number of content channels available to a user is expanded due to the virtual channels being mixed with broadcasted channels. A profile for a virtual channel may be constructed by either selecting channels or defining a type of program that are preferred to be consumed during a specific time period. A virtual channel may be created by comparing information in the profile that defines preferred channels with transmission units either with genre information or a list of channels that may be stored in a digital receiving device. The genre information may include metadata describing IP addresses, time intervals, names of channels and content. Local content may also be mixed with the virtual channels thereby providing an increased degree of customization of content.

### FIELD OF THE INVENTION

The invention relates to broadcast service. More particularly, the invention relates to systems and methods for creating a virtual broadcast service for a digital receiver device.

### BACKGROUND OF THE INVENTION

Broadcasting is a well-known general service for consumers. There are radio and TV broadcasts with many channels and programs. Broadcasting can be preformed over terrestrial radio, satellite, cable etc. It is know to broadcast over data networks, Internet, Ethernet and 2/3G cellular networks and others. Audio and video signals are most commonly broadcasted, and are becoming popular for digital broadcasting. Closed Captioning or Text-TV is an example of a digital broadcast. In a broadcasting environment, there are a broadcast source, which provides the program, and a number of receivers associated with consumers who can select a channel and program. Additionally, multicast class of networks might be used for broadcast type services.

DVB-T was first adopted as a standard in 1997, and is currently rapidly expanding in Europe, Australia and Asia. DVB-T offers about 24 Mb/s data transfer capability to a fixed receiver, and about 12 Mb/s to a mobile receiver using an omnidirectional antenna. While DVB-T was developed for MPEG-2 Transport stream distribution, it is capable of carrying other types of (non-video) data. For example, DVB-T can provide a broadband, mobile wireless data transport for video, audio, data and Internet Protocol (IP) data.

In a general broadcasting service, the consumer can select a channel/program the broadcaster produces according to a general audience. Thus, it is possible that no channel/program and content is desirable for the consumer at specific times. There are technical and economical limitations on the amount of channels/programs. Further, the transmission capacity might be limited to due to costs and technical considerations.

Thus, it would be an advancement in the art to provide a method of creating and implementing virtual channels that do not require substantial infrastructure upgrade and investment and provide a high degree of customization for a user.

### BRIEF SUMMARY OF THE INVENTION

To overcome limitations in the prior art described above, and to overcome other limitations that will be apparent upon reading and understanding the present specification, the present invention is directed to a system and method for creating a customized virtual broadcast service which can be used with a digital receiving device.

In one aspect, a mobile communications terminal includes a processor for controlling operation of the mobile terminal and a memory for storing computer executable instructions that, when executed by the processor, cause the mobile communications terminal to perform a method for establishing a virtual media channel. The method includes the steps of receiving a digital broadcast of a plurality of Internet Protocol (IP) data packets relating to a plurality of programs on a plurality of genre program channels on a radio frequency band, each of the genre program channels having associated therewith a data packet stream identifier, retrieving data defining a virtual media channel comprising two or more sequential elements indicating the genre program channels and corresponding data packet stream identifier, and controlling the mobile terminal to consume the received IP data packets on the basis of the data packet stream identifiers in the sequential elements to thereby provide the virtual media channel.

One aspect includes a method for representing virtual channels of a broadcast genre type in a display of IP datacasting receivers. Aspects of the invention are applicable to video and audio broadcasting via IP over Digital Video Broadcast (DVB) or IP time slicing over DVB. In one aspect, a profile for a virtual channel may be constructed by either selecting channels or defining a type of program that is preferred to be consumed during a specific time period. In another aspect, a virtual channel may be created by comparing information in the profile that defines preferred channels with transmission units either with genre information or a list of channels that may be stored in a digital receiving device. In yet another aspect, the genre information may include metadata describing IP addresses, time intervals, names of channels and content. In another aspect, local content may also be mixed with the virtual channels thereby providing an increased degree of customization of content.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a system architecture block diagram according to an illustrative embodiment of the invention.

FIG. 2 illustrates first program channel multiplexing arrangement according to an illustrative embodiment of the invention.

FIG. 3 illustrates second program channel multiplexing arrangement according to an illustrative embodiment of the invention.

FIG. 4 illustrates a third program channel multiplexing arrangement according to an illustrative embodiment of the invention.

FIG. 5 illustrates a fourth program channel multiplexing arrangement according to an illustrative embodiment of the invention.

FIG. 6 illustrates a flow process for implementing a virtual channel according to an illustrative embodiment of the invention.

FIG. 7 illustrates a schematic electronic program guide according to an illustrative embodiment of the invention.

FIG. 8 illustrates a schematic virtual electronic program guide according to an illustrative embodiment of the invention.

FIG. 9 illustrates selection profile table with metadata according to an illustrative embodiment of the invention.

FIG. 10 illustrates a display screen according to an illustrative embodiment of the invention.

FIG. 11 illustrates a schematic representation of the multiple electronic channels or electronic service guide.

FIG. 12 illustrates a system architecture block diagram for mixing local content with broadcasted content according to an illustrative embodiment of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

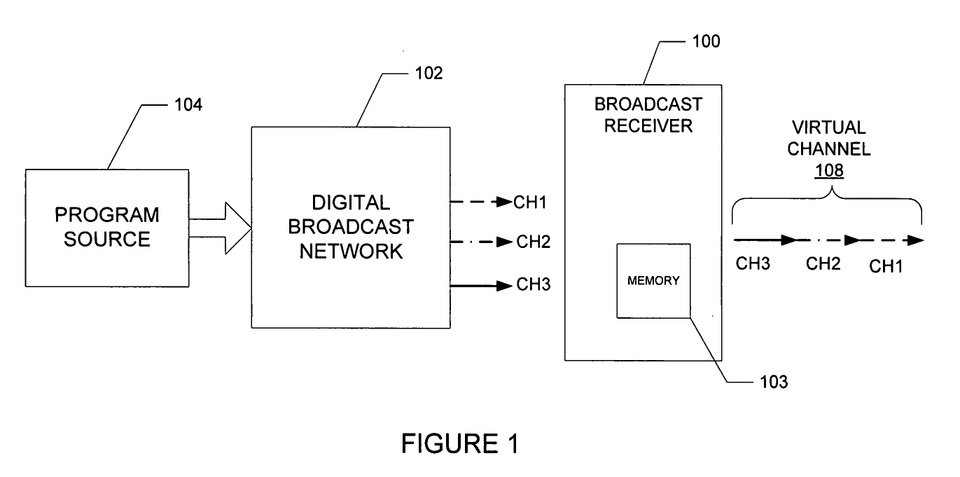

FIG. 1 shows a system for receiving and processing digital broadcast video signals in accordance with an embodiment of the invention. A digital broadcast receiver device 100, such as a set-top box, a personal video recorder (PVR), a personal digital recorder (PDR), a TV device, a radio device, a personal computer, or a mobile communication device, receives digital transmissions within a digital broadcast network 102 from one or more program content sources 104. In a (set-top box) configuration, digital broadcast receiver 100 may be coupled to a television (not shown). The digital broadcast receiver device 100 may optionally couple to a computer device (not shown). A central processing unit (CPU) may be included to control the overall operation of digital broadcast receiver device 100. Computer executable instructions and data used by CPU and other components within digital broadcast receiver 100 may be stored in a computer readable memory 103. The memory may be implemented with any combination of read only memory modules or random access memory modules, optionally including both volatile and nonvolatile memory. Alternatively, some or all of receiver device 100 computer executable instructions may be embodied in hardware or firmware (not shown).

Digital broadcast receiver device 100 may be configured to receive, decode and process transmissions based on the Digital Video Broadcast (DVB) standard. For example, DB receiver device 100 may include a DVB receiver (not shown). In an example of the DVB standard, one DVB 10 Mbit/s transmission may have 200, 50 kbit/s audio program channels or 50, 200 kbit/s video (TV) program channels. In one embodiment, the digital broadcast receiver device 100 may be configured to receive, decode, and process transmission based on the Digital Video Broadcast-Handheld (DVB-H) standard. Any other DVB standard, such as DVB-Satellite (DVB-S), DVB-Terrestial (DVB-T) or DVB-Cable (DVB-C). Nevertheless, any other digital transmission format may alternatively be used, such as ATSC (Advanced Television Systems Committee), NTSC (National Television System Committee), ISDB (Integrated services Digital Broadcasting) or DIRECTV. Additionally, the digital transmission may be time sliced, such as in DVB-H technology. In one embodiment, program channels CH1-CH3 include content based on a specific genre delivered at specific times to the digital broadcast receiver device 100. The genres may be, for example, general news, local news, business news, weather forecast, football games, baseball games, ice hockey games, general sport news, football news, motor sport news, cartoons for kids, sitcoms, comedy movies, horror movies, religious programs, nature & science programs, rock music, hip-hop music, jazz music, classical music, country music, the like.

With continued reference to FIG. 1, video and audio programs may be transmitted to digital broadcast receiver device 100 over a variety of different radio frequencies and/or in a multiplexed manner over a single carrier frequency. Digital broadcast receiver device 100 receives the genre channels and programs delivery the various genre channels based on time scheduling data. Namely, the program content may be delivered in transmission units based on a duration length and time slots. For example, the program may start and may end at the same time interval scheduling based on a clock. Interval steps or duration lengths may be, for example, 30 sec, 5 min, 15 min, 30 min or 60 min and the like. Optionally, a synchronization device, such as synchronizer or a timer, may be used to synchronize transmission of the transmission units from various different channel/program sources before transmission from the program source, because there might be time differences between transmission units on channels originated from different channel/program sources. Nevertheless, the digital broadcast receiver device 100 creates a customized virtual channel 108 which is mixed from the broadcast program channels (CH 1, CH2, CH3) based on presentation or consumption at a specific time. The digital broadcast receiver device 100 may comprise one or more or transmission or broadcasting receivers (not shown) that may simultaneously receive one or more transmissions and one or more IP transmission or broadcasting decoders (not shown) that may simultaneously decode one or more transmission. This enables fast channel changes within a frequency band even channels in different frequency bands. This also enables consuming one channel and simultaneously storing another channel in the device.

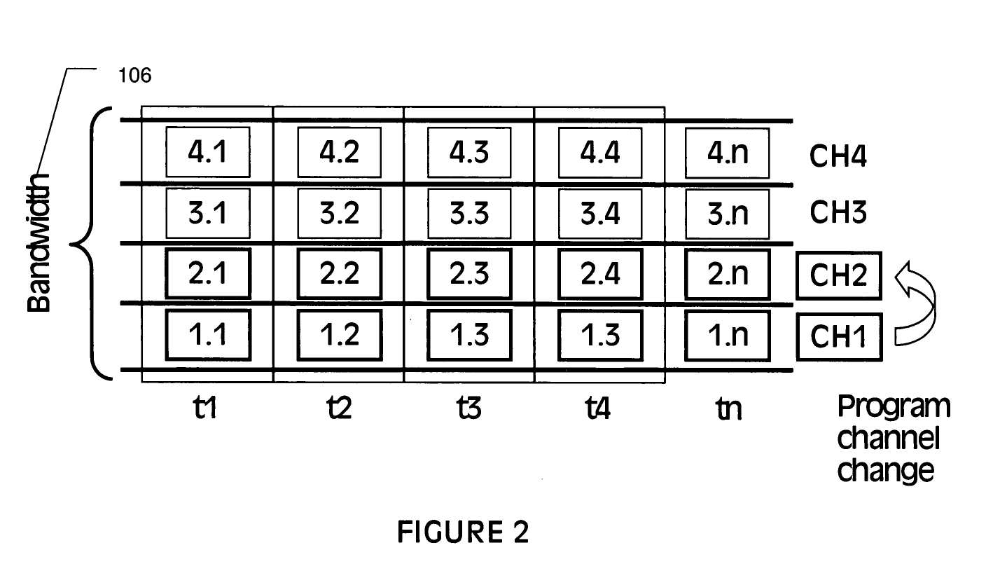

FIG. 2 shows an embodiment of a plurality of program channels in a multiplexed arrangement over a radio frequency band. In this embodiment, the bandwidth 106 is divided into data streams or subsets of data representing program channels for transmission to and processing by digital broadcast receiver device 100. The program channels may be arranged such that the data from the streams are arranged to be delivered in the same time slot or time slice. For example, a radio frequency bandwidth 106 includes multiple program channels (CH1, CH2, CH2, CH3, CH4) delivered in sequential time slices (t1, t2, t3, t4 . . . tn). Each program channel CH1-CH4 is allocated a portion of the bandwidth 106 for each time slice. Thus, DB receiver device 100 receives the program channels (CH1-CH4) at the same time. Each program channel may have associated therewith a data stream identifier, such as an IP data stream identifier or an IP address. This configuration enables a program channel change for pointing to different addresses for the data streams. In one IP datacasting (IPDC) implementation, multiple frequency tuning of the digital broadcast receiver device 100 can be eliminated because the data is provide at the same frequency transmission. Thus, digital broadcast receiver device 100 may navigate the program channels by changing an IP data packet stream identifier or IP address in an IP decoder (not shown) of digital broadcast receiver device 100.

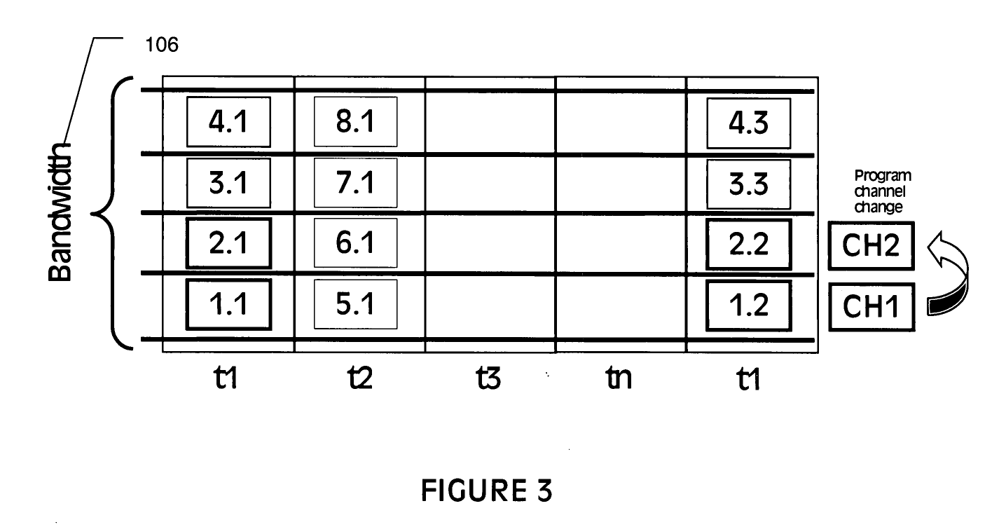

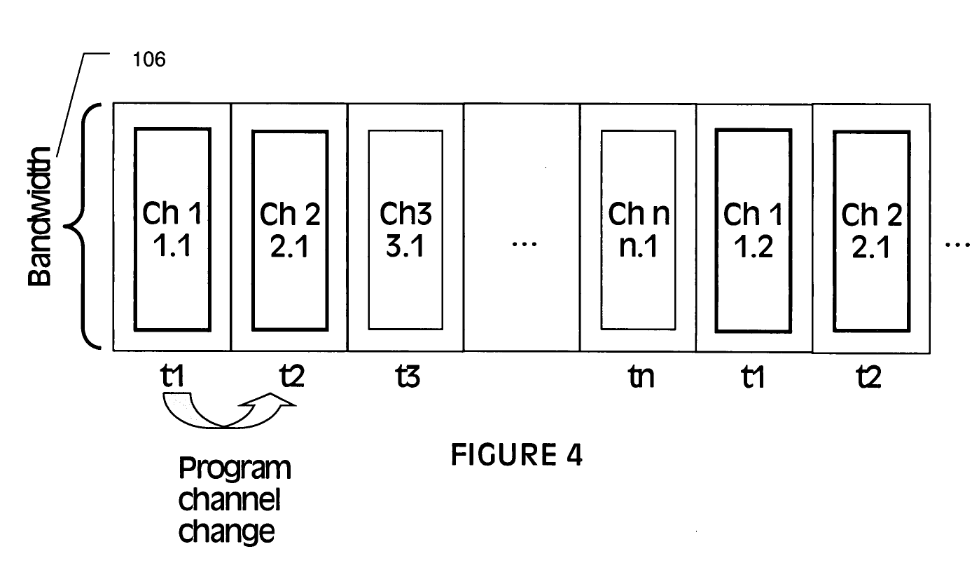

FIGS. 3 and 4 show embodiments of a plurality of program channels in a multiplexed arrangement over a radio frequency band. This arrangement enables the digital broadcast receiver device 100 to receive more than one genre program channel at the same time. For example, radio frequency bandwidth 106 includes eight program channels in sequential time slices (t1-t4 . . . tn). Each program channel may have a data stream identifier, such as an IP data stream identifier or an IP address. With reference to FIG. 3, a program channel change may be accomplished by changing the address designation in a receiver decoder of digital broadcast receiver device 100. With reference to FIG. 4, a program channel change may be accomplished by moving to a different time slice from t1 to t2. Nevertheless, there are other configurations possible. Embodiments of aspects of the present invention may comprise one or more digital transmission decoders for fast channel change.

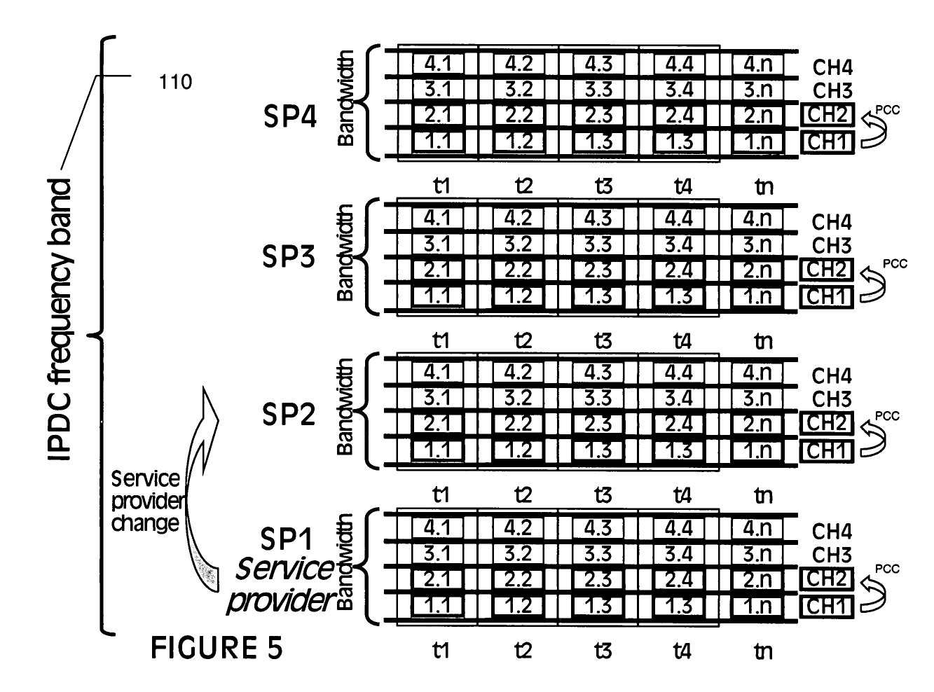

FIG. 5 illustrates one embodiment of a plurality of program channels being transmitted on a multiplicity of radio frequency bandwidths. In this alternative embodiment, an IPDC frequency bandwidth 110 is shared among a plurality of service providers SP1, SP2, SP3, SP4. If program channel is changed from one service provider to another service provider, the IP data packet stream identifier in the decoder is changed, in addition to the frequency bandwidth used for tuning. The change of genre channels may become faster when the digital broadcast receiver device 100 includes two or more receivers and two or more corresponding IP decoders. In this way, the other receiver and decoder pair may prepare the genre channel change in advance to be ready for a fast program channel change (PCC) at the specified time slot.

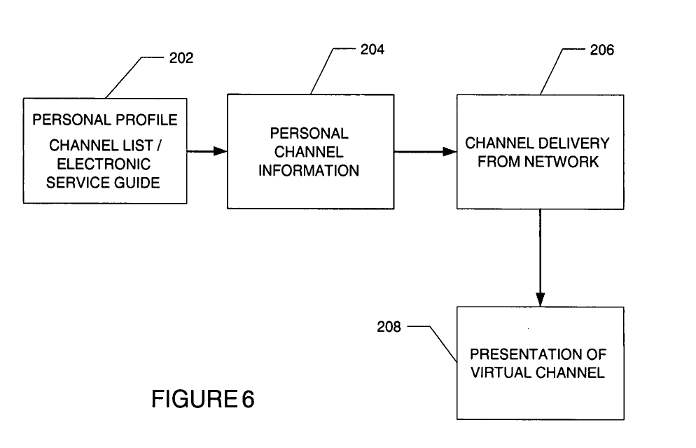

FIG. 6 illustrates an embodiment of a process flow for creating a personal virtual channel for a user with a digital receiving device, such as digital broadcast receiver device 100. In block 202, a user creates a personal profile of program content to be consumed at specific predetermined times. Knowledge of the service offerings becomes overwhelming to a media user, when hundreds or possibly thousands of different program channels on different mediums are available, such as on TV and radio broadcasting, and on the Internet. In one embodiment, a personal virtual channel may be created to manage the delivery of the program content to the digital broadcast receiver device 100.

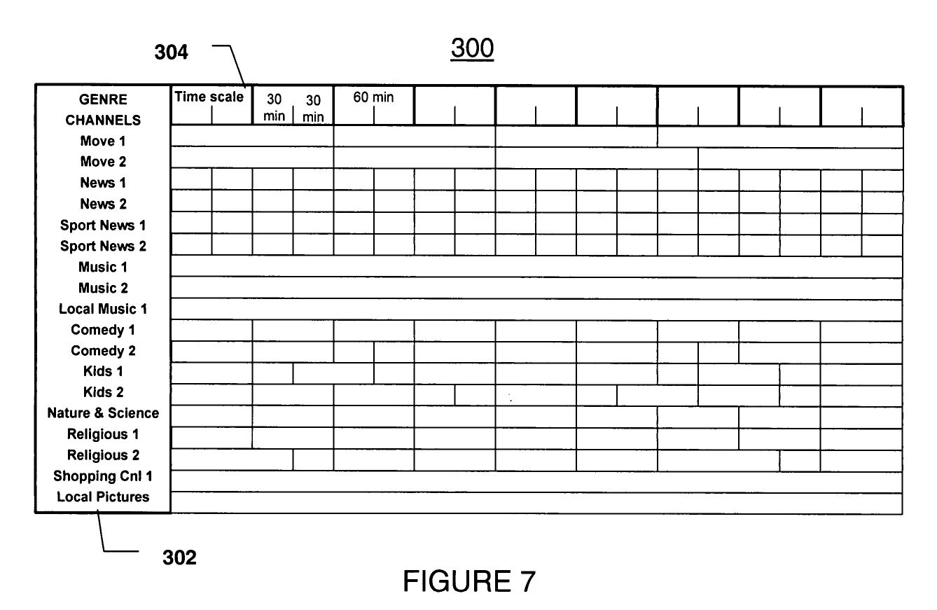

In block 202 of FIG. 6, a personal profile for a virtual channel may be constructed by enabling a user to select a specific channel from a group of genre channels to be consumed at a specific time period. Accordingly, a personal profile for a virtual channel can be created from a genre electronic service guide (ESG) 300 or a genre electronic program guide (EPG) 300 or an interactive service guide (IPG) shown in FIG. 7, which may be provided by one or more program producers or service providers for digital broadcast receiver device 100. Of course, program producers or service providers may have their own separate genre lists or there may be available a common genre list that combines content of all the separate genre lists or genre ESGes or a specific genre list that combines a specific content of all the separate genre lists of genre ESGes, such as a sports genre ESG. For user interaction, the genre ESG 300 may be displayed on a television in the case of a STB configuration. Alternatively, the genre ESG 300 may be shown on a small display screen with user interface functionalities in the case of a mobile communication device. Turning to FIG. 7, a vertical axis or channel column of the genre ESG 300 may include a plurality of genre channels 302 in a listing which pertain to specific program content. For example, the genre channels 302 include but are not limited to a Movie 1, Movie 2, News 1, News 2, Sport News 1, Sports News 2, Music 1, Music 2, Local Music 1 and the like. The horizontal axis of the genre ESG 300 may be a time scale 304 and time duration of content in the genre channels 302. In the example of FIG. 7, the time scale is divided into the 1 hour or a 60 minute time unit, and further segmented into 30 minute time units. Nevertheless, the time scale may be segmented into smaller time units, such as 30 sec, 5 min, 10 min and 15 min and the like, or larger time units than 60 minutes.

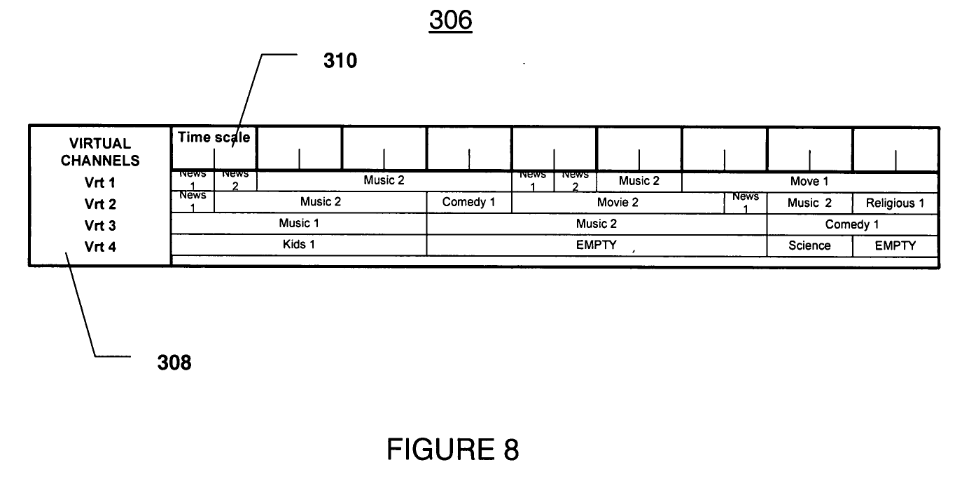

FIG. 8 illustrates a virtual electronic service guide (ESG) 306 of a multiplicity of virtual channel profiles which have been generated from the genre ESG 300 of FIG. 7. A vertical axis or vertical column of the virtual ESG 306 includes a plurality of virtual channel profiles 308 denoted as Vrt1, Vrt2, Vrt3, Vrt4. The data within the virtual ESG 306 may be stored in a computer readable memory of the digital broadcast receiver device 100. The horizontal axis or horizontal column of the virtual ESG 306 includes a time scale 310 with time duration of the content of the genre channels of genre ESG 300 of FIG. 7. In one embodiment, a user selects genre program channels that are to be consumed at a specific time period. For ease of explanation, the description will focus on virtual channel profile Vrt1. If desired, the media user of digital broadcast receiver device 100 may provide an identification name for the personal virtual channel. The user may select a specific time unit or units or time period. For example, a time unit or time period may be between 08:30-09:00 p.m. of a specific day when certain content of a genre channel is available. The user may select a preferred genre channel to be consumed at that specific period of time, e.g., step 202 of FIG. 6. Alternatively, a user may select a specific program to be presented at a specific virtual channel and at a specific day and time, e.g. “Friends” at 21:00 on Mondays. In the case of Vrt1, the user has selected genre channel sequential elements, such as the News 1 channel to be followed by content of the News 2 channel, and presented sequentially by the Music 2 channel and so forth. Nevertheless, there are numerous combinations of the genre channels that can be provided for visual and/or audio presentation associated with a virtual channel profile. Accordingly, program content may be customized for a specific user based on virtual channels profiles and the number of available content channels can be increased by mixing the broadcasted channels for sequential presentation in the virtual channels.

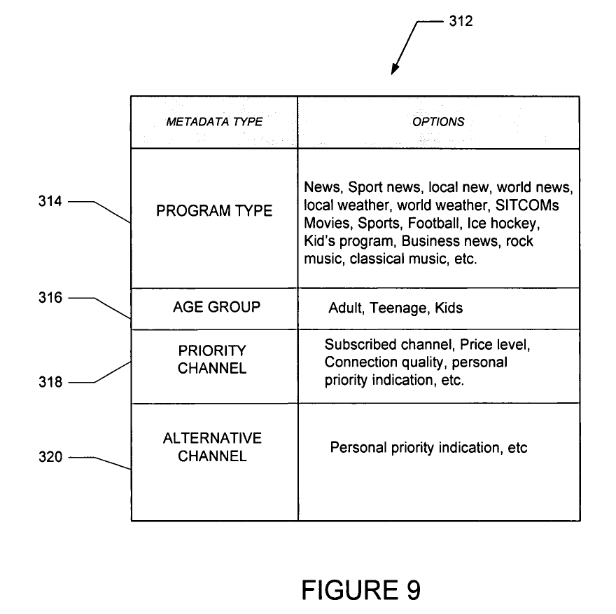

Alternatively, in block 202 of FIG. 6, a personal profile for a virtual channel may be constructed by enabling a user to define the type of programs that are preferred to be consumed at a specific time period, rather than selecting the actual genre channel. In this alternative embodiment, the specified program for delivery is picked from one of the genre channels of genre ESG 300 of FIG. 7 according to a selection profile 312 based on certain metadata types as shown in FIG. 9. For example, a program type attribute 314 relates to the class of the genre channels for a specific time period. An age group attribute 316 relates to the age appropriateness of the genre channel for possible parental guidance control. If desired, a priority channel attribute 318 may pertain to certain types of factors for channel selection in accordance with a priority rule algorithm. An alternative channel attribute 320 may be used. To create the personal profile, the media user of digital broadcast receiver device 100 may provide an identification name for the personal virtual channel. Additionally, the user may select a specific time unit or units or time period. Finally, a media user may select a preferred type of program to be consumed from a relevant genre channel at that specific period of time based on the selection profile.

With reference to FIG. 6, in block 204, personal channel information of the preferred channels in the virtual profile is associated with IP data packet identifiers or IP addresses and receiving times of program content of the channels. A user does not need to know the IP address or packet identifiers. When a virtual channel profile or component thereof are constructed by selection of the preferred channel, the virtual channel is created by comparing the information in the profile with the sequential transmission units with a genre electronic service guide (or EPG or IPG) having the channel IP data packet identifiers or IP addresses, which may be stored in the digital broadcast receiver device 100. Alternatively, the virtual channel may be created with the virtual channel profile and a list of genre channels.

With reference to FIG. 7, in an embodiment, genre ESG 300 includes information on IP addresses or IP data packet stream identifiers that define the genre channels, and the names and/or identifiers of the incoming programs to be delivered via the genre channels. Nevertheless, genre ESG 300 may include metadata information related to a specific channel and/or program. The metadata information may describe IP addresses or IP data packet stream identifiers that define the genre channels, time interval of a broadcasting system, genres of the channels, names of the channels, names of programs, codes of programs, content of the programs, type of the programs, transmission (start and end) times of programs, or the like. The genre ESG 300 with corresponding information is transmitted via the broadcast network 102 and stored in a memory of digital broadcast receiver device 100.

With reference to FIG. 6, in blocks 206 and 208, a virtual channel may be created by program logic in a CPU of receiver device 100 retrieving the stored virtual channel profile, such as Vrt 1 shown in FIG. 8. When time goes on, then at the appropriate time slot, the program logic points to the corresponding IP addresses or an IP data packet stream identifiers in the broadcast network 102 to receive the program content. In this way, the digital broadcast receiver device 100 may control the consumption of the data packets associated with the genre channels at a specific time. Nevertheless, the media user may also have a personal virtual ESG indicating the names of the coming programs in the virtual channel as shown in FIG. 8. Alternatively, a list of channels may have only information on the IP addresses or the IP data packet stream identifiers that define the genre channels. That is, names of the coming programs may not be available. The virtual channel may be created by the digital broadcast receiver device 100 pointing to the corresponding IP addresses or IP data packet stream identifiers for the genre channels for a specific time slot.

With continued reference to FIG. 6, in block 204, an alternative way to create a virtual channel is to compare the information in the virtual profile that defines the preferred program types with transmission units with information in genre ESG 300. In this alternative embodiment, the list of the IP addresses or the IP data packet stream identifiers do not provide enough information to find the genre channels having the preferred program based on a selection profile, such as shown in FIG. 9. Genre ESG 300 may include metadata information describing the content of the genre channels, the incoming programs on the channels, IP addresses or IP data packet stream identifiers that define the genre channels, etc. The metadata information is compared with the virtual profile information. In blocks 206 and 208, a virtual channel may be created by program logic in a CPU of receiver device 100 retrieving the stored virtual channel profile and selection profile 312. Then at the appropriate time slot, the logic selects the program content in a genre channel based on the metadata in the selection profile for program type and points to the corresponding IP addresses or IP data packet stream identifiers in the broadcast network 102 to receive the selected program content. In this way, the digital broadcast receiver device 100 may control the consumption of the data packets associated with the genre channels at a specific time. Optionally, if there are available multiple channels delivering program content that fit the user selection profile, priority rules may be used to select the program or channel that is represented to the user. In yet another option, if any of the programs in the program types of the genre channels do not fit the user selection profile, an alternative program may be presented to the user.

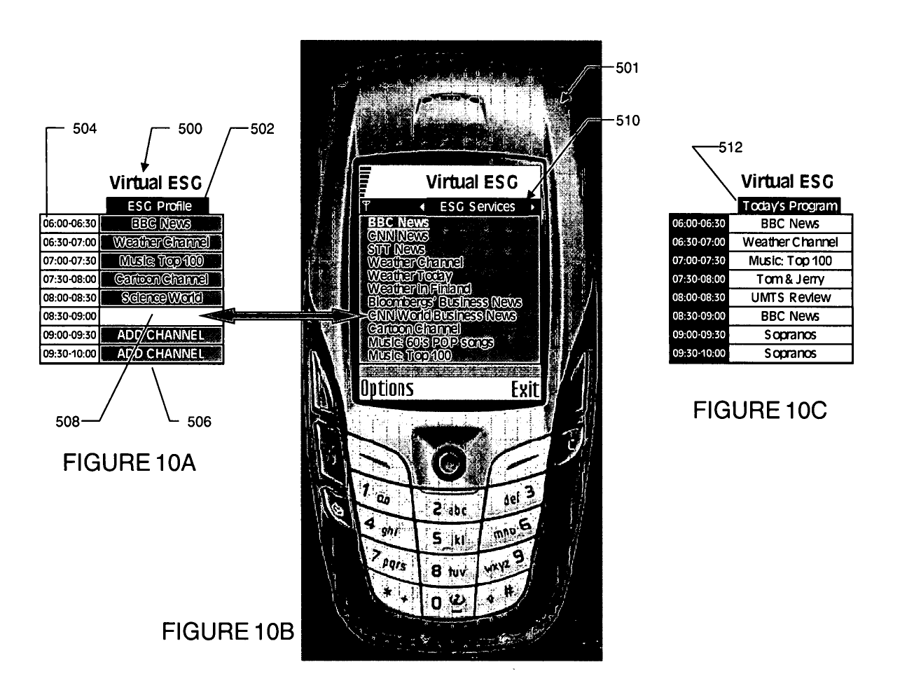

FIGS. 10A-10C show aspects of a personal Virtual ESG 500 presented on a digital broadcast receiver 501 in the form of a mobile communication device having a display and user interface functionalities. With reference to FIG. 10A, that describes a creation of a virtual channel profile 502, a time scale 504 may be presented on the vertical axis with corresponding genre channels or type of program content 506. The time scale 504 may show time units or transmission units determined by a service provider. In this embodiment, the time units are 30 min increments, but a duration of the smallest time unit may vary, e.g., from 5 min to 60 min. In the right column are cells related to the time units for selected program channels. The user may create a personal ESG profile 502 by selecting one or more specific genre channels to be presented at specific times from the list 510 that may open as a pop-up window or menu. An example of this feature is depicted for the time scale 504 with respective to the 09:00-09:30 and 9:30-10:00 time slots as “ADD CHANNEL.” Thus, the user receives the content that is normally scheduled for broadcast on the specific channel. Alternatively, a user may create personal ESG profile 502 by defining the type of program content (e.g., FIG. 9) on the respective genre channels 506, and at what times the user is willing to watch those specific programs. For example, the 08:30-09:30 time slot may be used. In another alternative, a user may define periodic patterns for receiving content such as, every weekday and separately for weekends. For example, a user may want business news and weather on weekdays and more leisure activity content on weekends. In this way, a user may have different channels for presentation on different days.

FIG. 10B shows an embodiment of an ESG Services template which can be used for personal profile creation. When selecting a preferred program channel to the time unit, a user can scroll up and down the columns in the template. By activating a cell 508 in FIG. 10A, a virtual channel application may open an “ESG Services” window or pop-up menu 510 shown in FIG. 10B. The window 510 may list the available program channels for user selection. The user may scroll up and down the list and select a preferred program channel such as “BBC News.” When the selection of the preferred channels for the ESG profile is ready, the user may store the ESG Profile 502 in the mobile communication device 501. In the FIG. 10C, a “Today's Program” view 512 of the Virtual ESG 500 may present a list of the actual programs that will be broadcasted at the selected time units based on the ESG Profile 502. As shown in FIG. 10C, the cell corresponding to cell 508 in FIG. 10A now has “BBC News” and the Cartoon Channel has a specified program called “Tom & Jerry”.

The “ADD CHANNEL” representations in FIG. 10A has been substituted with a program content entitled “Sopranos” for the 09:00-09:30 and 9:30-10:00 time slots. Thus, a user may use a virtual ESG for creation of a virtual channel and may readily substitute programs or genre channels in various time slots for presentation.

It should be recognized that a virtual ESG may be generated by collecting different personal profiles into one ESG. The virtual ESG may present several virtual channels that may be defined by one user or, alternatively, by separate users. For example, referring to FIG. 7, Vrt1 (virtual channel 1) may be a user's working day profile and Vrt2 may be the user's Sunday profile, and so on. Alternatively, Vrt1 may be for a father's virtual channel, Vrt2 for a mother's virtual channel, and Vrt4 for kids, and so forth. The virtual ESG shows names of the programs on the virtual channels to be presented in the future. In an alternative embodiment, the virtual ESG may be presented as a part of the genre ESG and/or the common ESG. In this way, an electronic service guide may have information of the actual channels and virtual channels for use. Nonetheless, creation of the Virtual ESG may happen by similar manner in a set-top box device as well. This allows simpler creation due the larger size of the display and enhanced user interface functionality.

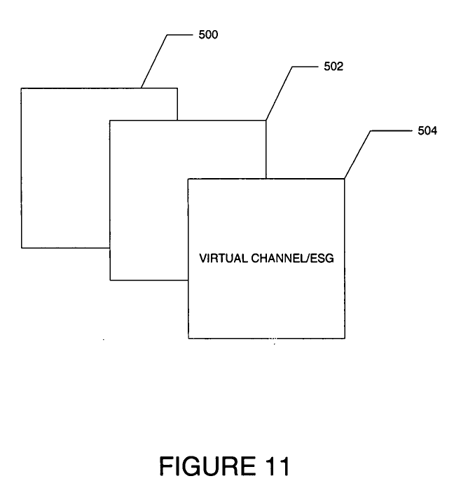

In one embodiment, shown in FIG. 11, a third party entity, such as a TV/Radio program producer, telecom operator, media company, or other service provider, may also provide customized or previously defined virtual channel profiles or virtual ESGs/EPGs 500-504 that are created for specific user groups, topics and/or specific purposes. For example, the user groups may include but are not limited to teenagers, girl teenagers, boy teenagers, kids, adults, homemakers or the like. The topics may be such as business profile, family profile, sport profile, movie profile, “Tom Cruise movies this week” profile, news profile, radio profile or the like. The special purposes may be such as Christmas profile, Sunday profile, Summer Olympic 2004 profile or the like. A user may order and/or purchase the virtual ESGs and profiles, download them via any transmission network and save them in a digital device, such as digital broadcast receiver device 100. Additionally, users may edit these previously defined profiles to add their personal preferences. Advantageously, the previously defined ESGs/EPGs profiles ease the user's work to define a personal ESG profile among hundreds, even thousands of different sources available on TV, radio and web broadcasting, and also from a memory attached to the digital device. Of course, TV/Radio program producers or service providers may offer the virtual ESGs/EPGs profiles with or without an extra charge to the user.

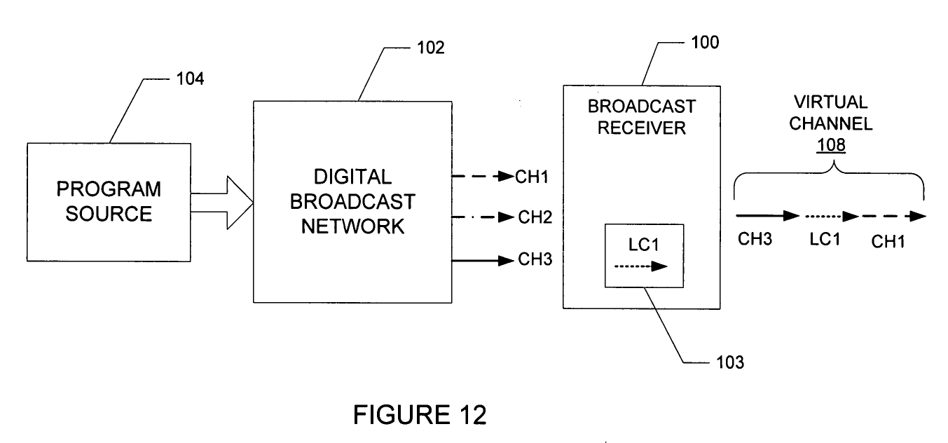

FIG. 12 shows a system for receiving and processing digital broadcast video signals in accordance with an embodiment of the invention in which local content is mixed with broadcast channels. A digital broadcast receiver device 100 (set-top box, a radio device, a personal computer, a TV device, or mobile communication device) receives digital transmissions within a digital broadcast network 102 from one or more program content sources 104. With respect to the digital broadcast receiver device 100, local content (LC1) may be stored within memory 103. The local content (LC1) may be computer readable data, such as music, photos, pictures, videos, text, and the like. The local content may have an address identifier associated with a digital file using well known conventions. The user may select local content from the memory 102 of the digital broadcast receiver device 100 to be presented between certain time intervals. Thus, the digital broadcast receiver device 100 creates a customized virtual channel 108 which is mixed from the broadcast transmission program channels and local content (CH 1, LC1, CH3) based on presentation or consumption at a specific time. The local content may be downloaded to the digital broadcast receiver device 100 in advance, e.g., at night, or when a usage of the device is low or when the usage of the transmission or delivery network is low. The local content may also be created by a user or downloaded peer-to-peer. In some cases, the program producers or service providers make the programs with commercials or an introduction part to fill the whole transmission unit. If some programs do not last to the end of the transmission unit, the time gap may be filled with the local content from the digital broadcast receiver device 100. In these ways, a virtual channel includes highly customized content for the user.

With reference to FIG. 1, in one embodiment, a scheduled program may be stored in the memory 103 of the digital broadcast receiver device 100 prior to the scheduled presentation. To accomplish this feature, the program may be transmitted prior to presentation and stored for later playback. In case that some programs are transmitted fully or partially at the same time with other programs, the programs that are not presented to a user may be stored in the memory for later presentation. These features are useful if any channels or programs are selected that are not synchronized with the total broadcasting content.

One or more aspects of the invention may be embodied in computer-executable instructions, such as in one or more program modules, executed by one or more computers, set top boxes, mobile terminals, or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Thus, a system for representing virtual channels of a broadcast genre type in a display of IP datacasting receivers has been described. The aspects of the invention are applicable to video and audio broadcasting via IP over Digital Video Broadcast (DVB) or IP time slicing over DVB. In one arrangement, the number of content channels available to a user is expanded due to the virtual channels being mixed with broadcasted channels. A profile for a virtual channel may be constructed by either selecting channels or defining a type of program that are preferred to be consumed during a specific time period. A virtual channel may be created by comparing information in the profile that defines preferred channels with transmission units either with genre information or a list of channels that may be stored in a digital receiving device. The genre information may include metadata describing IP addresses, time intervals, names of channels and content. Local content may also be mixed with the virtual channels thereby providing an increased degree of customization of content.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

1. A terminal, comprising:
a processor for controlling operation of the terminal;
a memory storing computer executable instructions that, when executed by the processor, cause the terminal to perform a method for establishing a virtual channel, comprising:
(a) receiving a digital broadcast of a plurality of Internet Protocol (IP) data packets relating to a plurality of programs on a plurality of genre program channels on a radio frequency band, each of the genre program channels having associated therewith a data packet stream identifier;
(b) retrieving data defining the virtual channel comprising at least two sequential elements indicating the genre program channels and corresponding data packet stream identifiers; and
(c) controlling the terminal to consume the received IP data packets on the basis of the data packet stream identifiers in the at least two sequential elements to thereby provide the -virtual channel.

2. The terminal according to claim 1, wherein the terminal is one of a mobile terminal, a set-top box, a television device, a radio device, and a personal computer.

3. The terminal according to claim 1, wherein in step (a) the digital broadcast comprises digital video broadcast.

4. The terminal according to claim 1, wherein in step (a) the genre program channels include video and audio content.

5. The terminal according to claim 1, wherein in step (b) one of the at least two sequential elements includes a text representation of content associated with the genre program channels.

6. The terminal according to claim 1, wherein in step (b) the data defining the virtual channel is customized by a service provider.

7. The terminal according to claim 1, wherein step (c) includes a step of controlling the terminal to provide a stream of local data associated with one of said at least two sequential elements.

8. The terminal according to claim 7, wherein said stream of local data associated with one of said at least two sequential elements comprises audio content.

9. The terminal according to claim 7, wherein said stream of local data associated with one of said at least two sequential elements comprises graphics content.

10. The terminal according to claim 1, further comprising a step of displaying an indication of the genre program channel having the IP data packets being consumed, the indication being displayed on a display device of the terminal.

11. The terminal according to claim 10, wherein the indication comprises text.

12. The terminal according to claim 1, wherein in step (b) the data is retrieved responsive to a selection profile indicating the genre program channels.

13. The terminal according to claim 12, wherein the genre program channels are selected by a user.

14. The terminal according to claim 12, wherein the genre program channels are determined by a profile of a user.

15. The terminal according to claim 1, wherein in step (b) the data is retrieved responsive to a selection profile indicating preferences of a user.

16. The terminal according to claim 1, wherein step (c) includes a step of changing the IP data packets for decoding in a decoder based on the data defining the virtual channel.

17. The terminal according to claim 1, further comprising at least one IP data packet decoder.

18. The terminal according to claim 17, wherein step (a) includes a step of decoding at least one IP data packet stream simultaneously.

19. The terminal according to claim 1, further comprising at least one IP data packet receiver.

20. The terminal according to claim 19, wherein step (a) includes a step of receiving IP data packet streams on at least one radio frequency band simultaneously.

21. The terminal according to claim 1, wherein step (c) includes a step of changing the IP data packets for decoding in a decoder based on a profile.

22. A method of representing a virtual channel of broadcasted genre type channels in a display of an IP datacasting receiver device, the method comprising the steps of:
(a) receiving a digital broadcast of a plurality of Internet Protocol (IP) data packets relating to a plurality of programs on a plurality of genre program channels on a radio frequency band, each of the genre program channels having associated therewith a data packet stream identifier;
(b) retrieving data defining a virtual channel comprising at least two sequential elements indicating the genre program channels and corresponding data packet stream identifiers; and
(c) controlling the receiver device to consume the received IP data packets on the basis of the data packet stream identifiers in the at least two sequential elements to thereby provide the virtual channel.

23. The method according to claim 22, wherein in step (a) the digital broadcast comprises digital video broadcast.

24. The method according to claim 22, wherein in step (a) the genre program channels include video and audio content.

25. The method according to claim 22, wherein in step (b) one of the at least two sequential elements includes a text representation of content associated with the genre program channels.

26. The method according to claim 22, wherein step (c) includes a step of controlling the receiver device to provide a stream of local data for one of said at least two sequential elements.

27. The method according to claim 26, wherein said stream of local data for one of said at least two sequential elements comprises audio content.

28. The method according to claim 26, wherein said stream of local data for one of said at least two sequential elements comprises graphics content.

29. The method according to claim 22, further comprising a step of displaying an indication of the genre program channel having the IP data packets being consumed, the indication being displayed on the display of the IP datacasting receiver device.

30. The method according to claim 29, wherein the indication comprises text.

31. The method according to claim 22, wherein in step (b) the data is retrieved on the basis of a selection profile indicating the genre program channels.
